(19) United States
(12) Patent Application Publication
(10) Pub. No.: US 2024/0394689 A1
(43) Pub. Date: Nov. 28, 2024

(54) SECURE WALLET FOR STORING ASSETS IN A MULTI-CHAIN, MULTI-PARTY INTERFACE

(71) Applicant: COSMIC WIRE INC., Marina Del Rey, CA (US)

(72) Inventors: Mark ELLIS, Prescott, AZ (US); Jerad FINCK, Marina Del Rey, CA (US); Mike MUMOLA, Kearny, NJ (US); Greg PARKER, Bethlehem, CT (US)

(21) Appl. No.: 18/676,277

(22) Filed: May 28, 2024

Related U.S. Application Data
(60) Provisional application No. 63/469,154, filed on May 26, 2023.

(51) Int. Cl. G06Q 20/36

(52) U.S. Cl. CPC G06Q 20/36

(57) ABSTRACT

Technologies for providing secure cryptocurrency wallet include a system that receives a request from an external party to conduct a cryptocurrency transaction with a user of a cryptocurrency wallet. The cryptocurrency wallet is instantiated using a public key and a private key. A temporary key is generated based on one or more parameters associated with the wallet. The cryptocurrency transaction is conducted using the temporary key in place of the public key.

### CROSS-REFERENCE TO RELATED APPLICATIONS

This patent application claims priority to U.S. Provisional Patent Application Ser. No. 63/469,154, entitled “TECHNIQUES FOR PROVIDING A SECURE CRYPTOCURRENCY WALLET,” filed May 26, 2023, which is incorporated by reference in entirety herein.

### TECHNICAL FIELD

This disclosure generally relates to blockchain technology, and more specifically, to a digital wallet for conducting secure transactions over various media.

### BACKGROUND

A cryptocurrency wallet uses distributed ledger technology (e.g., blockchain) to allow an owner of the wallet to manage a variety of digital currencies or other indicators of value. With a cryptocurrency wallet, the owner may store cryptocurrency or other indicators of value, conduct secure transactions with external parties (e.g., sending cryptocurrency, receiving cryptocurrency, making purchases using cryptocurrency, etc.), track transaction activity, and the like.

The term “cryptocurrency” may be understood by some in the public to primarily refer to traded non-fiat currencies, such as Bitcoin and Ethereum. It is known in the field, however, that techniques used to engage in transactions using non-fiat currencies can also be used in a sandboxed or tokenized system (e.g., a decentralized virtual or augmented reality environment) to exchange tokens or other indicators that either have value themselves or reflect value, e.g., are an identifier of fiat currency, non-fiat currency, commodities, securities, or other items of value.

A typical implementation of a cryptocurrency wallet is a software program associated with a private and public cryptographic key. The wallet uses both to access and transfer cryptocurrency (or other crypto asset, such as non-fungible tokens), particularly in signing transactions. While the private key is intended to remain known only to the owner of the wallet, external parties may reference a public key (also known as a wallet address) when conducting wallet transactions with the owner.

One concern with the typical private and public encryption key scheme is that the wallet may nevertheless continue to be exposed to security and privacy risks due to inherent transparency. For example, attackers can possibly use the wallet's public key to infer information about the wallet or the owner, such as transaction activity. As digital transactions and cryptocurrencies continue to gain traction, preservation of privacy and security in financial exchanges is of importance.

### SUMMARY

Embodiments presented herein disclose a secure virtual wallet for storing and engaging in transactions to exchange or provide access to cryptocurrencies, tokenized securities, sensitive information or other virtual identifiers that either have or reflect value. For example, one embodiment of the present disclosure provides a method that generally includes receiving a request from an external party to conduct a cryptocurrency transaction with a user of a cryptocurrency wallet. The cryptocurrency wallet is instantiated using a public key and a private key. A temporary key is generated based on one or more parameters associated with the wallet. The cryptocurrency transaction is conducted using the temporary key in place of the public key.

Another embodiment of the present disclosure provides a computer-readable storage medium storing instructions, which, when executed, causes a system to receive a request from an external party to conduct a cryptocurrency transaction with a user of a cryptocurrency wallet. The cryptocurrency wallet is instantiated using a public key and a private key. A temporary key is generated based on one or more parameters associated with the wallet. The cryptocurrency transaction is conducted using the temporary key in place of the public key.

Yet another embodiment of the present disclosure provides a system having one or more processors and a memory storing instructions, which, when executed causes the system to receive a request from an external party to conduct a cryptocurrency transaction with a user of a cryptocurrency wallet. The cryptocurrency wallet is instantiated using a public key and a private key. A temporary key is generated based on one or more parameters associated with the wallet. The cryptocurrency transaction is conducted using the temporary key in place of the public key.

The secure wallet can be associated with media, including digital environments and augmented and virtual reality environments, where the wallet is associated with or integrated into one or more virtual “avatars” or aspects of the environment itself. An avatar can (but need not be) associated with or depicted as an image, e.g., a two- or three-dimensional image of a person, animal, cartoon, brand identifier, or other visual representation. Avatars may be associated with or reflect a person, a group of people, or an association or enterprise. Avatars may exchange messages between or among them, or otherwise interact with a digital environment or augmented or virtual reality environment, in addition to engaging in transactions involving the secure wallet. Messages can consist of video, static picture, text, audio, or any mixture thereof, limited only to the ability of the receiving user to interpret the file type, and may be accompanied or associated with a transaction involving the secure wallet.

### BRIEF DESCRIPTION OF THE DRAWINGS

The foregoing aspects and other features of the disclosure are explained in the following description, taken in connection with the accompanying example appendices relating to one or more embodiments.

FIG. 1 is a conceptual diagram illustrating an example computing environment of a metaverse platform providing a digital wallet for providing secure transactions, according to an embodiment;

FIG. 2 is a conceptual diagram illustrating various media over which secure transactions may be conducted using the digital wallet of FIG. 1, according to an embodiment;

FIG. 3 is a block diagram illustrating components of an example computing system, according to an embodiment;

FIGS. 4-8 are example user interface views for features of a secure cryptocurrency wallet provided by the metaverse platform of FIG. 1, according to an embodiment;

FIG. 9 is a flow diagram illustrating a method for conducting a secure transaction via the digital wallet of FIG. 1, according to an embodiment; and

FIG. 10 is a flow diagram illustrating a method for generating a stealth address for use in conducting a secure transaction using the digital wallet of FIG. 1.

### DETAILED DESCRIPTION

Embodiments presented herein disclose systems and techniques for providing a secure cryptocurrency wallet that preserves owner privacy during usage of the wallet, e.g., in conducting transactions with other parties. In particular, the techniques include generating a one-time use encryption key in place of a public key or wallet address in transactions. Doing so thereby obfuscates the wallet address from another party during the transaction as well as renders wallet activity untrackable.

The term “cryptocurrency wallet” is used throughout to describe the secure wallet's functionality. The same disclosed methods, systems, and instructions used to engage in transactions using non-fiat cryptocurrencies can also be used in a sandboxed or tokenized system (e.g., a decentralized virtual or augmented reality environment) to exchange tokens or other indicators that either have value themselves or reflect value, e.g., are an identifier of fiat currency, non-fiat currency, commodities, securities, or other items of value. The cryptocurrency wallet may also be included in or associated with one or more avatars in a digital environment and/or augmented or virtual reality environment.

Among other things, the wallet may be used to store and/or engage in transactions involving cryptocurrencies, tokenized securities, or other items that have or reflect value. The wallet may also incorporate or use the tokens as reflected herein, including the “TOKEN STANDARD IMPLEMENTATION FOR TOKENIZED SECURITIES” disclosed in U.S. patent application Ser. No. 18/620,769, filed on Mar. 28, 2024, which is incorporated by reference in entirety herein. For example, the secure wallet of the present disclosure may receive a secure token with one or more transfer restrictions based in part on one or more identified characteristics associated with the account. The wallet may manage requests to transfer the token to a recipient account associated with a regulated transfer group.

As further described herein, the cryptocurrency wallet may leverage adaptive obfuscation techniques to minimize the risk of deanonymization (e.g., through network traffic analysis). To do this, the cryptocurrency wallet may incorporate techniques such as dynamic routing path adjustments (e.g., to account for node reputation, latency, network topology, and the like), variable obfuscation levels (e.g., to provide tunable privacy allowing users to balance privacy preferences with transaction throughput), and integrating with existing anonymity networks (e.g., Tor, I2P, etc.) for additional layers of privacy. In addition, the cryptocurrency wallet may generate one-time public key-based stealth addresses over which to carry out a transaction, and further have the transaction sent to a pool of multiple transactions of different senders and receivers to create an additional layer of privacy. Advantageously, doing so results in observers being highly unlikely to link multiple transactions to a single wallet or identify the parties involved in a given transaction.

In addition, the cryptocurrency wallet may be used to conduct secure cryptocurrency or other secure transactions (e.g., secure tokenized transactions) of a given over various media, such as physical point-of-sale (POS) systems, digital POS systems, different cryptocurrency exchanges, and the like, regardless of the currency specified for the recipient. For example, a user may conduct a transaction using the wallet to provide or receive a specified amount of Ethereum to a physical POS system that receives the amount as a fiat currency.

A user may also conduct a transaction using the wallet to provide or receive a specified item of value in exchange for a token or other identifier of value. The specified item of value may be a real-world good as well as media or a virtual good, such as video, static picture, text, audio, or any mixture thereof, limited only to the ability of the receiving user to interpret the file type. The specified item of value may also be a service to be provided in the real world via a smart contract or in a digital environment and/or virtual or augmented reality environment, e.g., via interactions with one or more avatars or the digital environment and/or virtual or augmented reality environment.

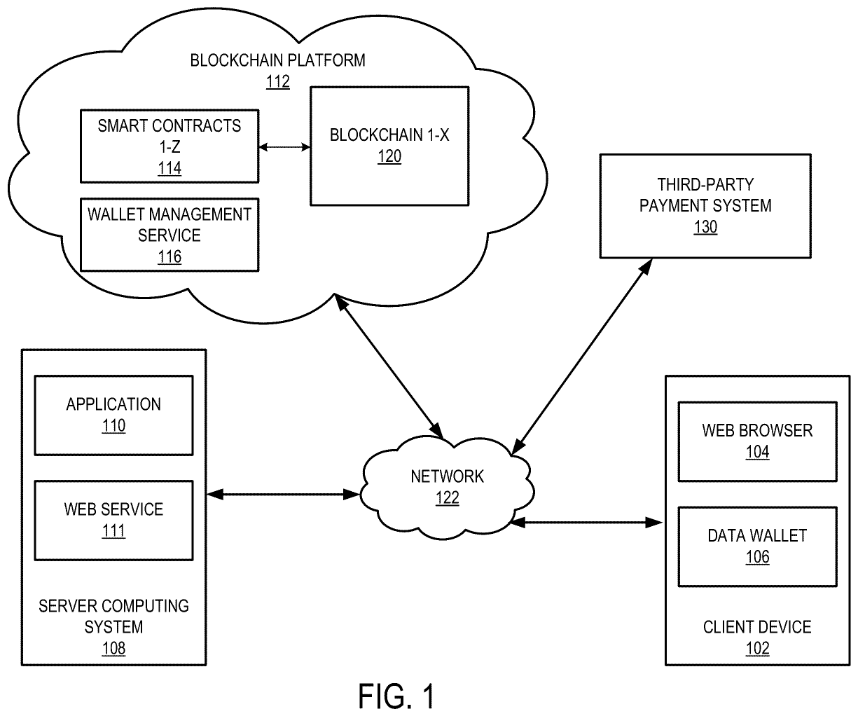

FIG. 1 illustrates an example computing environment 100 in which a secure cryptocurrency wallet may be implemented. Illustratively, the computing environment 100 includes a client device 102, a server computing system 108, a blockchain platform 112, and a third-party payment system 130 each interconnected via a network 122 (e.g., the Internet).

The illustrative client device 102 represents a computing system operated by an individual user. The client device 102 may be embodied as any physical computing device (e.g., a desktop computer, laptop computer, workstation, etc.) or a virtual computing device (e.g., a virtual machine instance executing on a physical computing device or on a cloud platform).

As shown, the client device 102 includes a web browser 104 and a data wallet 106. The web browser 104 is a software application that accesses content provided by websites over the network 122 and presents the content on a display of the client device 102. In an embodiment, the data wallet 106 is a client-side interface that provides functions for a user to manage collection, storage, and usage of crypto-based user data and assets, such as cryptocurrency tokens (including tokenized securities or other indicators of value), Non-Fungible Token (NFT) data, and the like.

The user can also, using the wallet 106, conduct cryptocurrency transfer transactions, in which the cryptocurrency wallet owner may transfer an amount of a specified cryptocurrency funds to a recipient (in which the recipient may be identified through various means, such as by email, telephone number, social media username, etc.), convert an amount of cryptocurrency funds to an amount of funds in another cryptocurrency, and use market data obtained from various sources to ascertain a present conversion rate for a given cryptocurrency. A user may also conduct a transaction using the wallet to provide or receive a specified item of value in exchange for a token or other identifier of value. The specified item of value may be a real-world good as well as media or a virtual good, such as video, static picture, text, audio, or any mixture thereof, limited only to the ability of the receiving user to interpret the file type. The specified item of value may also be a service to be provided in the real world via a smart contract or in a digital environment and/or virtual or augmented reality environment, e.g., via interactions with one or more avatars or the digital environment and/or virtual or augmented reality environment.

The exchanges of cryptocurrencies or other specified items of value may take place in a block-chain based virtual environment. The virtual environment may be digital and may be a volumetric environment. The virtual environment may also use virtual or augmented reality to facilitate transactions of cryptocurrencies or other identifies of value for specified items of value between or among, e.g., one or more avatars in the environment. Avatars in the virtual environment may be depicted as video, static picture, text, audio, or any mixture thereof, or they may reflect holograms or three-dimensional images, including three dimensional image captures of humans. The virtual environment may include marketplace and social media aspects, either in separate aspects or as part of a uniform whole.

An implementation of the virtual environment may use volumetric dataset for generating or enabling temporal-coherence uniform topology and UV atlas, particularly with regard to a volumetric three-dimensional object or model; and in turn enable to apply to such items a variety of tools, effects, graphical/visual effects, animation effects, texture effects, and/or other modifications which may be deployed or performed in an efficient manner. In this implementation, the method or system of using the wallet may be accompanied by one or more compression technologies to facilitate transactions involving cryptocurrencies or other items of value where users are in a bandwidth-limited environment, such as on a mobile device. Exemplary compression technologies are disclosed in, e.g., U.S. Pat. Nos. 11,721,114, 11,514,646, and 11,127,206, all of which are incorporated by reference herein.

The user may also manage an address book of contacts within a user interface provided by the wallet 106. Doing so simplifies sending and receiving cryptocurrency or other items of value by allowing users to associate these common identifiers with specific wallet addresses. Traditionally, sending and receiving cryptocurrency requires the use of long and cumbersome public keys or wallet addresses, which is often error prone. The address book disclosed herein provides an intuitive interface for a user to save and manage contact information. With an address book, users can associate their contacts' email addresses, social media handles, or other identifiers with their wallet addresses. The address book may also contain identifiers or indicators of the avatars of other users and/or their virtual locations within a virtual environment. This information is then stored in the user's wallet, making it easy to quickly send or receive cryptocurrency without needing to enter long addresses. In an embodiment, the wallet 106 is configured to hide a wallet address during a transaction with a third-party to preserve privacy of the owner of the wallet.

Avatars associated with the owner of the wallet may be securely maintained on blockchain to preserve their integrity and identify such avatar as associated with a particular user. The system may user one or more verification systems to ensure that an avatar is associated with a particular wallet and/or a particular user to mitigate the risk of fake accounts or fraud. These verifications may use transactions on the blockchain or other known verification processes to secure the avatar and wallet.

Illustratively, the server computing system 108 represents one or more computing systems and/or pool of computing resources of an entity providing providing a metaverse application platform and a server-side interface for the data wallet 106. Each server computing system 108 may be a physical computing device (e.g., a hardware server in a datacenter, a desktop computer, etc.) or a virtual computing instance executing in a cloud network.

Illustratively, the server computing system 108 includes an application 110. In an embodiment, the application 110 may execute and draw resources from multiple instances of server computing systems 108. In this example embodiment, the server computing system 108, via the application 110, hosts a simulated virtual world (the “metaverse”) for client devices 106. The metaverse may include the digital, augmented and virtual reality environments disclosed herein, including the disclosed compression technologies to permit interfaces on bandwidth-limited devices, and may include one or more avatars as disclosed herein. The client device 102 may access the metaverse via a client application, through a web service 111 accessed through the web browser 104, or through augmented and/or virtual reality devices or interfaces.

The illustrative blockchain platform 112 represents a decentralized immutable ledger peer-to-peer network on which blockchain-based applications and services may execute on a number of computing nodes. In an embodiment, the example blockchain platform 112 is an Ethereum Virtual Machine (EVM)-compatible blockchain subnet that is scalable. As shown, the blockchain platform 112 includes smart contracts 1-z 114 and a wallet management service 116. Although FIG. 1 depicts the smart contracts 1-z 114 and wallet management service 116 as separate components, other embodiments may provide each of the services 114 and 116 as a combined service within the blockchain platform 112. The blockchain platform 112 also includes one or more blockchains 1-x 120. Each blockchain 1-x 120 represents a distributed database storing a ledger of transactions that is replicated on each computing node within the platform 112. The one or more blockchains 1-x 120 may be used to store, manage, and execute smart contracts 1-z 114. Each smart contract 1-z 114 may be indicative of a self-executing contract including a number of terms that may be expressed as conditions having associated actions that are executed when the condition is satisfied or otherwise triggered. A service may generate and configure the smart contract 1-z 114 (e.g., setting parameters and provisions for a given smart contract). The wallet management service 116 facilitates user actions on the data wallet 106 within the blockchain platform 112 and on the blockchains 1-x 120, such as cryptocurrency and securities token transactions, data storage, and data management.

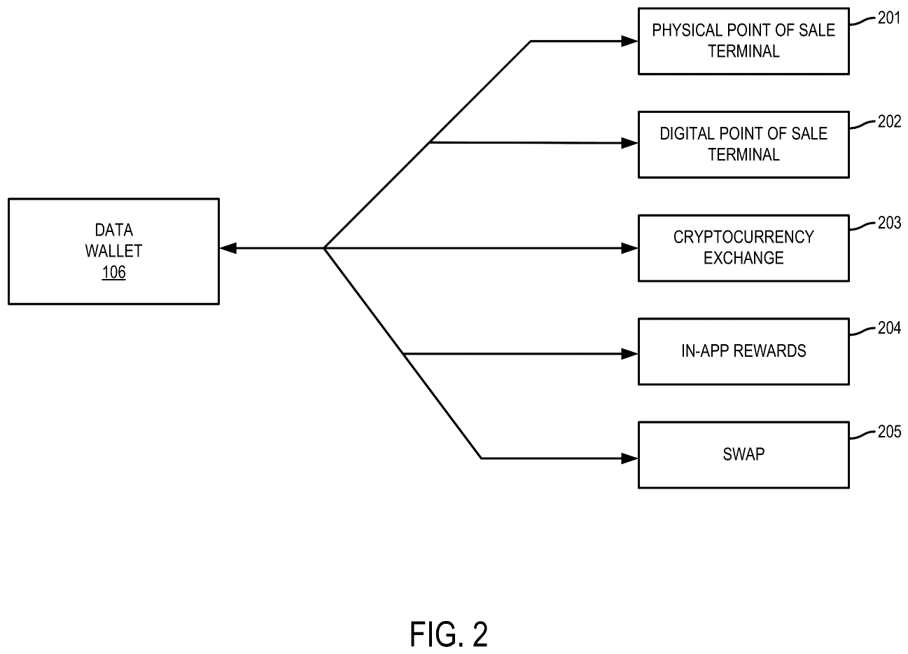

As stated, the platform provides a cryptocurrency wallet that enables a user to manage cryptocurrency funds and conduct cryptocurrency transactions as well as exchange identifiers of value for real or virtual goods or services, such as with other users of the metaverse platform, one or more third-party payment systems 130, and the like. Referring to FIG. 2, a conceptual diagram is shown to provide examples of media over which transactions can be conducted via the data wallet 106, the examples of which include a physical point of sale (POS) terminal 201, digital POS terminal 202, various cryptocurrency exchanges 203, in-app rewards 204 (e.g., rewards provided by the metaverse platform, such as crypto assets including NFTs), swap functions 205, and so on. Of course, the aforementioned media are merely provided as examples over which secure transactions may be conducted using the data wallet 106, and other examples may be contemplated.

In an embodiment, the data wallet 106 is configured to hide a wallet address during a transaction with another party to preserve privacy of the owner of the data wallet 106. In an embodiment, the data wallet 106 incorporates an encrypted metadata storage, which is a client-side cryptographic technique that ensures the privacy of user-generated metadata (e.g., transaction labels, address book entries, and sender and receiver information). The encrypted metadata storage may apply a variety of encryption schemes, such as authenticated encryption with associated data (AEAD), to protect sensitive metadata from unauthorized access and tampering. Though encrypted metadata storage, users are able to store and manage metadata locally on a device, such that no third-party or remote server can access the user's private information. Further, the encrypted metadata storage allows encrypted metadata to be securely synchronized across multiple devices, enabling users to access and manage wallet data from different platforms while maintaining privacy. Further still, the wallet provides access control mechanisms (e.g., biometric authentication and multi-factor authentication) for protecting metadata from unauthorized access. By encrypting metadata at the wallet level, a user can maintain full control over wallet data on a secure level.

In an embodiment, the wallet may also split a user's private key into multiple independently encrypted segments (also referred to herein as “shards”) to provide additional security by ensuring that no single point of failure compromises the user's private key. To do so, embodiments may employ secret sharing schemes (e.g., Shamir's Secret Sharing) to distribute encrypted shards across multiple user-selected devices or secure storage locations. To access the wallet or sign transactions, the user reassembles a predefined threshold of shards. Through such technique, the wallet prevents unauthorized access thereto and also ensures that a loss of a single shard does not result in the loss of the user's access to wallet data. Further, in the event that a shard is compromised, the shard may be regenerated by the user, thus allowing the wallet to remain secure. Advantageously, sharding private keys allows shards to be distributed across multiple locations to provide added protection against theft, hacking, or device failure. In addition, a user is able to customize a threshold required to reconstruct the private key. Further, in the event of device loss or failure, the user can recover a private key by securely reconstructing the private key from remaining shards.

In an embodiment, the wallet may also implement a stealth address generation technique with a transactional pool in which unique addresses are created for each transaction while pooling multiple transactions to further obfuscate the link between sender and receiver. Stealth address generation leverages Elliptic Curve Cryptography (ECC) and one-time key pairs to generate new addresses on-the-fly and thus provide an additional layer of privacy and prevent address reuse. The transactional pool adds another dimension of privacy by mixing multiple transactions within the pool, which makes it difficult for an observer to identify the sender and the receiver and the amount transacted.

In an embodiment, the stealth address generation techniques described herein generates unique addresses for each incoming transaction using a combination of the sender's and receiver's public keys, along with a random nonce. This process results in a one-time public key for each transaction.

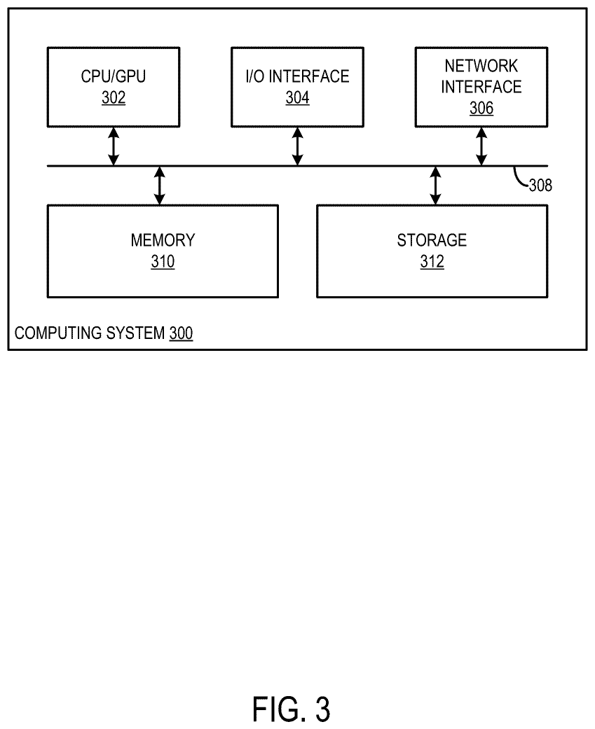

Turning now to FIG. 3, an example block diagram of a computing system 300 (which may be representative of any of the server computing system 108, client device 102, and/or systems providing the services of the blockchain platform 112) is shown. As shown, the server computing system 300 includes, without limitation, a central processing unit (CPU)/graphics processing unit (GPU) 302, an I/O device interface 304, a network interface 306, a memory 310, and a storage 312, each interconnected via a hardware bus 308. Of course, the actual computing system 300 will include a variety of additional hardware (or software-based) components not shown. Additionally, in some embodiments, one or more of the illustrative components may be incorporated in, or otherwise form a portion of, another component.

The CPU/GPU 302 retrieves and executes programming instructions stored in the memory 310. The CPU/GPU 302 may be embodied as one or more processors, each processor being a type capable of performing the functions described herein. For example, the CPU/GPU 302 may be embodied as a single or multi-core processor(s), a graphics processor, a microcontroller, or other processor or processing/controlling circuit. In some embodiments, the CPU/GPU 302 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 308 is used to transmit instructions and data between the CPU/GPU 302, storage 312, network interface 306, and the memory 310. CPU/GPU 302 is included to be representative of a single CPU, multiple CPUs, a single CPU having multiple processing cores, a graphics processor, and the like. The memory 310 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 306 may be embodied as any hardware, software, or circuitry (e.g., a network interface card) used to connect the computing system 300 over the network 122 and provide the network communication component functions described above. For example, the network interface 306 may be embodied as any communication circuit, device, or collection thereof, capable of enabling communications over the network 122 between the computing system 300 and other devices (e.g., server computing system 108 or client device 102). The network interface 306 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 306 may include a network interface controller (NIC, not shown), embodied as one or more add-in-boards, daughtercards, controller chips, chipsets, or other devices that may be used by the computing system 300 for network communications with remote devices. For example, the NIC may be embodied as an expansion card coupled to the I/O device interface 304 over an expansion bus such as PCI Express.

The I/O device interface 304 allows I/O devices to communicate with hardware and software components of the computing system 300. For example, the I/O device interface 304 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 304 may form a portion of a system-on-a-chip (SoC) and be incorporated, along with one or more of the CPU/GPU 302, the memory 310, and other components of the computing system 300. The I/O devices (not shown) may be embodied as any type of I/O device connected with or provided as a component to the computing system 300, such as keyboards, mice, and printers.

The storage 312 may be embodied as any type of devices configured for short-term or long-term storage of data such as, for example, memory devices and circuits, memory cards, hard disk drives (HDDs), solid-state drives (SSDs), or other data storage devices. The storage 312 may include a system partition that stores data and firmware code for the storage 312. The storage 312 may also include an operating system partition that stores data files and executables for an operating system.

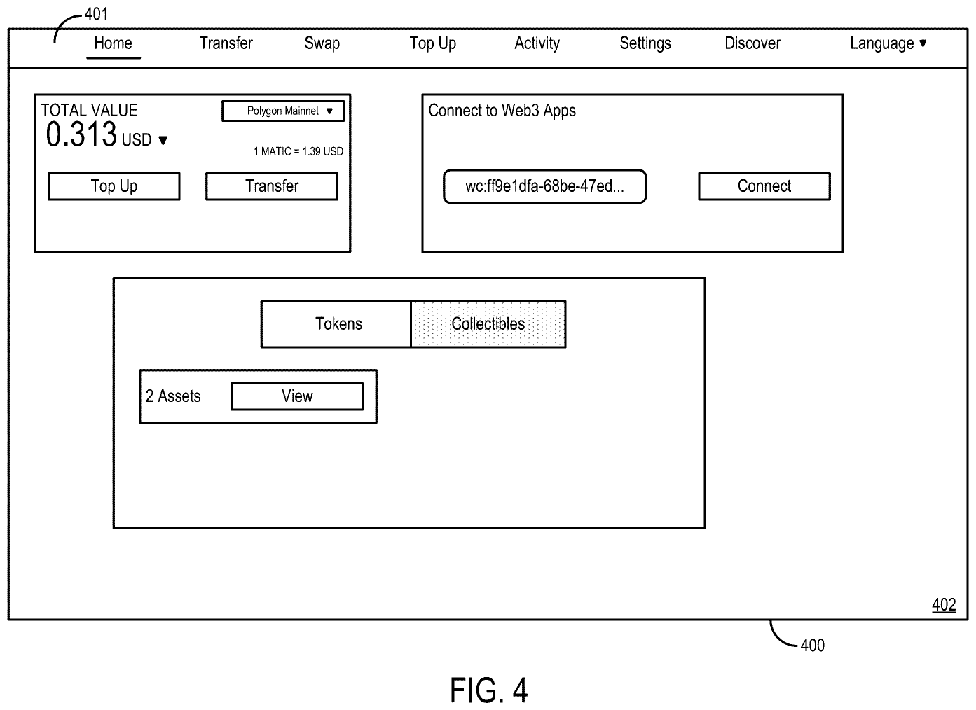

FIGS. 4-8 show example views of a cryptocurrency wallet graphical user interface (GUI) 400 provided by the application 110 and displayed on the client device 102, in which the privacy and security techniques described herein may be adapted. As shown in each of the FIGS. 4-8, a menu bar 401 listing example features (e.g., “Home”, “Transfer”, “Swap”, “Top Up”, “Activity”, “Settings”, “Language”) is provided on the GUI 400.

FIG. 4 provides a view 402 in which the “Home” feature is selected, which provides a landing page for the wallet owner that displays containers including, for example, account details, such as balances of cryptocurrency accounts or other identifiers of value, libraries for assets such as tokens and NFTs, and an option to enable the user to connect to, e.g., a Web3 app or a webpage at a given address. The home feature may also contain information concerning any virtual environment associated with the wallet, including any avatar(s) or virtual assets associated with a user. The user may, though the view 402, conduct select transactions, such as topping up funds (adding more funds of a given currency to the wallet), transferring funds to a recipient, or sending or receiving media (including messages), to others, including via the wallet's address book.

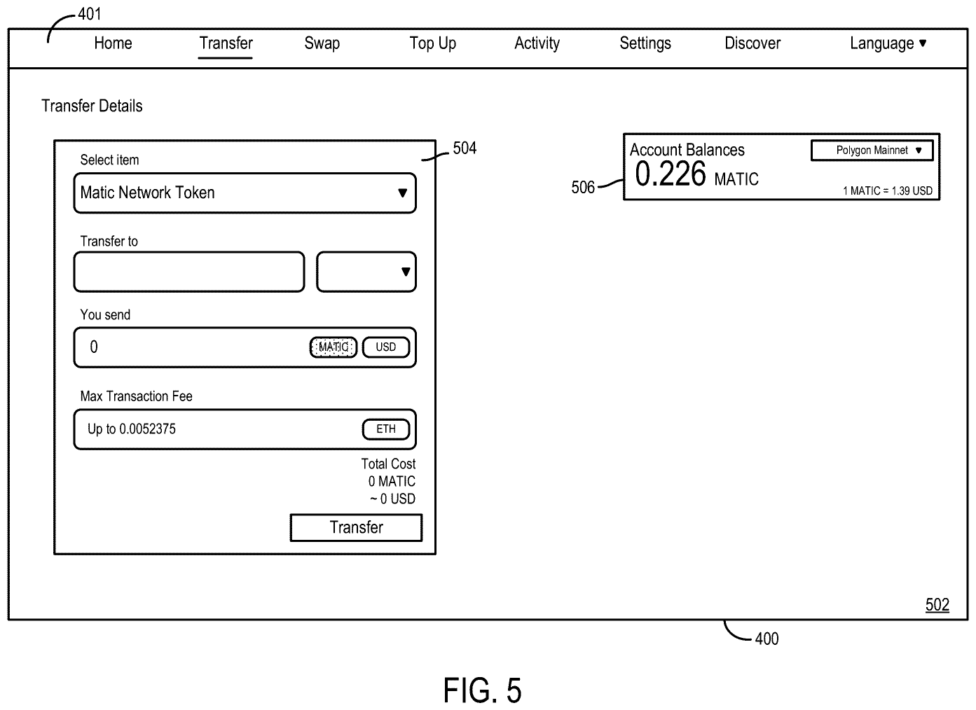

FIG. 5 shows a view 502 in which the “Transfer” feature is selected, which provides a page for conducting cryptocurrency transfer transactions, in which the cryptocurrency wallet owner may transfer an amount of a specified cryptocurrency funds to a recipient (in which the recipient may be identified through various means, such as by email, telephone number, social media username, identifying credentials provided by a near field communication (NFC) mechanism (e.g., at a POS terminal), etc.). The view 502 provides a container 504 which allows a user to specify, e.g., an asset (here, a Matic Network Token), a recipient of the asset, an amount to transmit. The container 504 also provides information as to transaction fees, and a calculation of the total cost including the transaction fees to conduct the transaction. The view 502 also provides a container 506 displaying an account balance of the user for the particular asset.

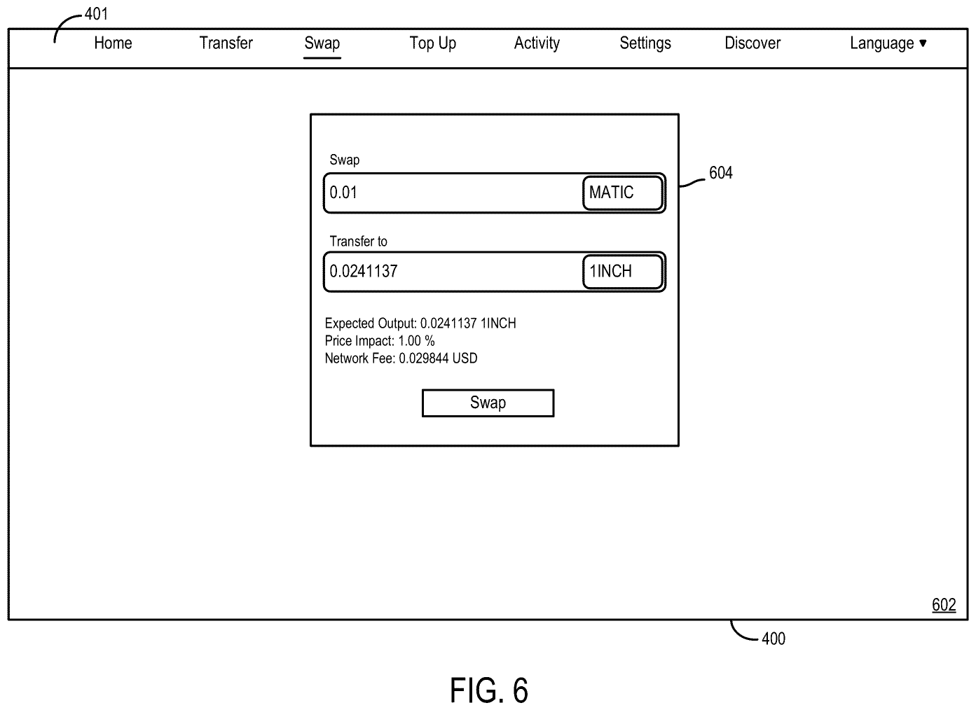

FIG. 6 shows a view 602 in which the “Swap” feature is selected, which provides a container 604 in which the user may convert an amount of cryptocurrency funds to an amount of funds in another cryptocurrency. In an embodiment, the cryptocurrency wallet may use market data obtained from various sources to ascertain a present conversion rate for a given cryptocurrency.

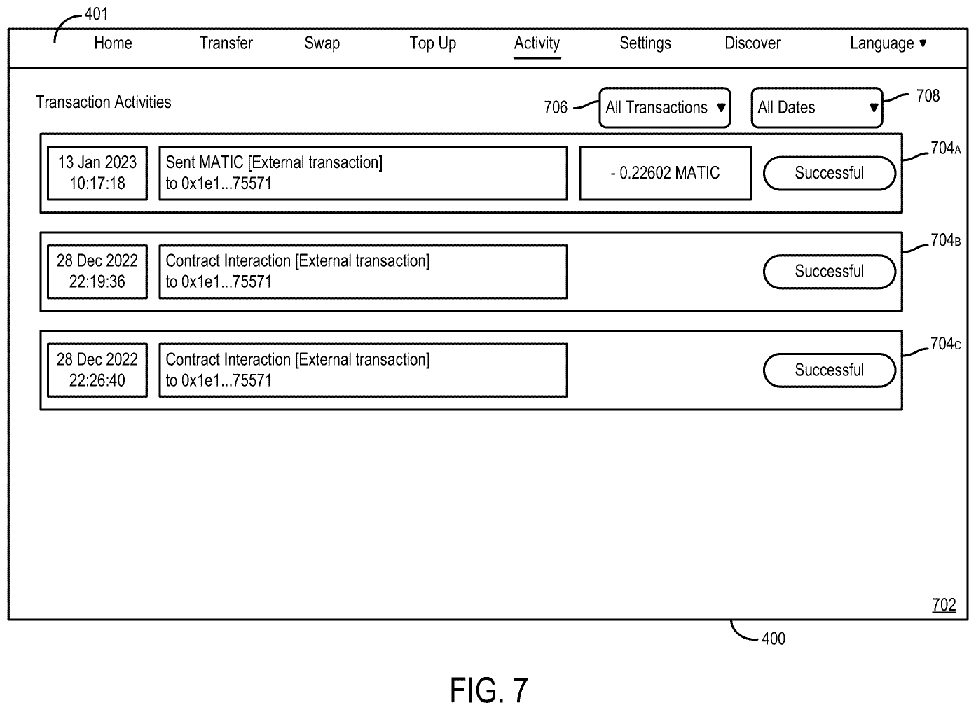

FIG. 7 shows a view 702 in which the “Activity” feature is selected, which provides a page displaying previous transaction activity conducted via the data wallet 106. The illustrative view 702 displays containers 704 (here, 704_{A-C}) displaying the type of transaction, the status associated with each transaction, the date of the transaction, an amount involved in the transaction, etc. The list of transactions is filterable by various parameters, such as by using a transaction type dropdown box 706 and a date range dropdown box 708.

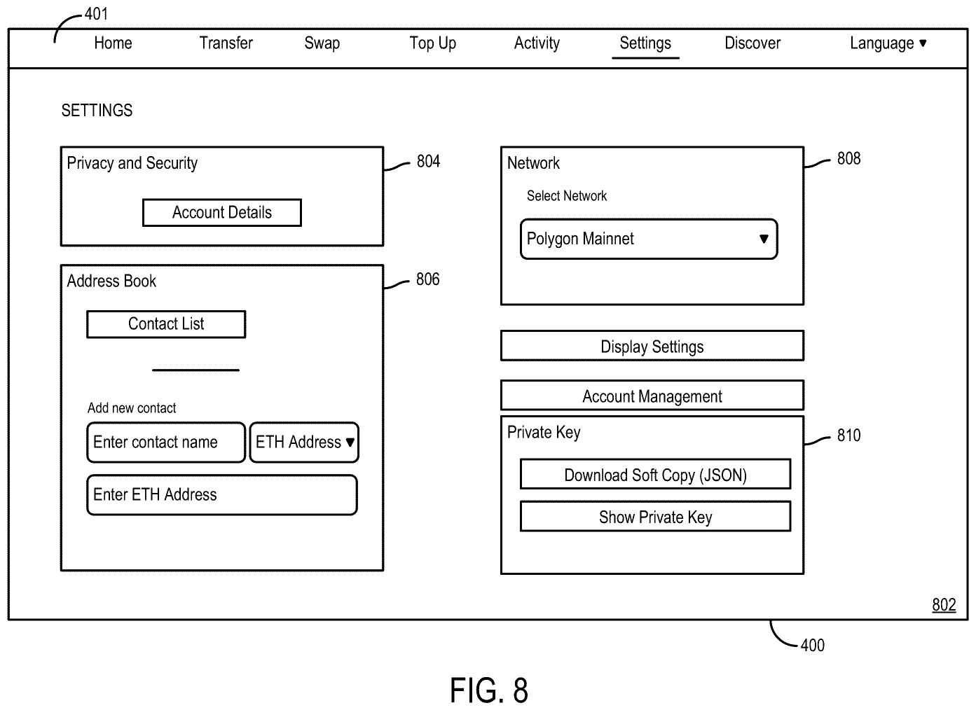

FIG. 8 shows a view 802 in which the “Settings” feature is selected, which provides a page displaying user configuration and settings. As examples, the view 802 provides a container 804 for configuring privacy and security settings associated with a user account, a container 806 for managing a list of contacts with which the user may conduct transactions, a container 808 for selecting a network to which the data wallet 106 should be connected, and a container 810 for displaying and downloading a private key associated with the data wallet 106. The user may also manage an address book of contacts within the user configuration and settings page, in which contact information can take a variety of identification parameters (e.g., name, telephone number, user id on different social media sites, email address, user id on the metaverse platform, etc.). The address book allows users to save and organize contacts by different identifiers such as email addresses, social media handles, and so on. Doing so simplifies sending and receiving cryptocurrency by allowing users to associate these common identifiers with specific wallet addresses. Traditionally, sending and receiving cryptocurrency requires the use of long and cumbersome public keys or wallet addresses, which is often error prone. The address book disclosed herein provides an intuitive interface for a user to save and manage contact information. With an address book, users can associate their contacts' email addresses, social media handles, avatars, or other identifiers with their wallet addresses. This information is then stored in the user's wallet, making it easy to quickly send or receive cryptocurrency without needing to enter long addresses. For example, if a user wants to send cryptocurrency or another identifier of value to a friend or business partner, the user may simply select the friend's name form the address book and enter the desired amount to send. The wallet automatically retrieves the corresponding wallet address associated with that name and use it to complete the transaction.

In an embodiment, the GUI also enables a user to obtain additional cryptocurrency funds from cryptocurrency provider services using fiat currency or other cryptocurrencies. In an embodiment, the wallet may integrate translation software (e.g., provided by a third party entity, such as the Stanford Language Lab, or self-developed) to support live transaction services and chat conversations for users across multiple languages. In an embodiment, the translation software is based on machine learning algorithms trained on large datasets of human language.

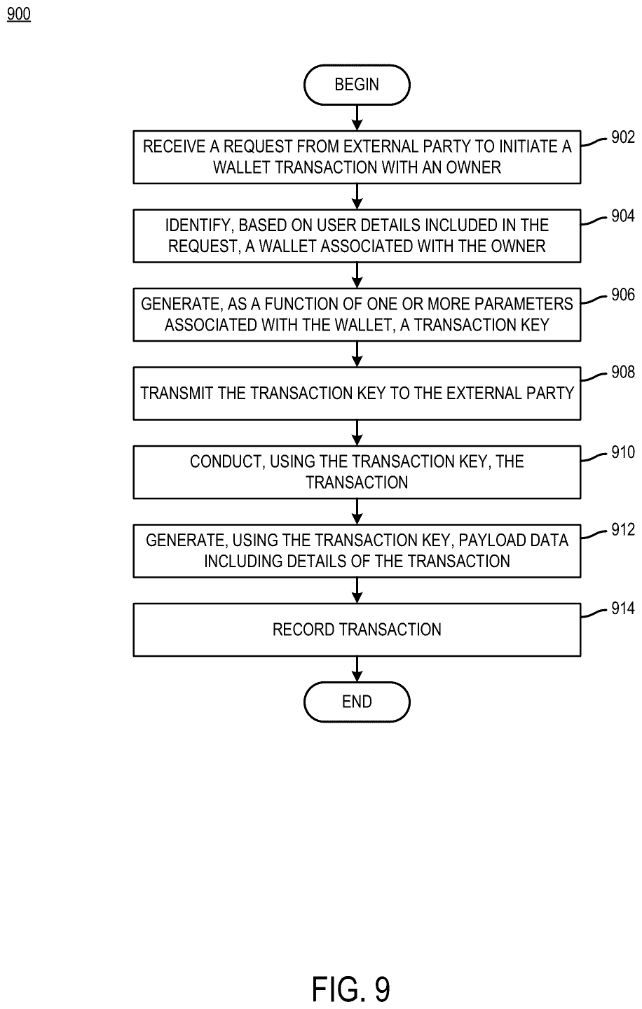

FIG. 9 illustrates an example method 900 for conducting a secure cryptowallet transaction according to an embodiment herein. As shown, the method 900 begins in block 902, in which the data wallet 106 receives a request from an external party (e.g., a contact listed in the owner's wallet address book) to initiate a wallet transaction with the owner. For example, the request may be sent by another platform user via the user interface. In block 904, the data wallet 106 identifies, based on user details included in the request, a wallet associated with the owner. For example, the data wallet 106 may correlate a username associated with a particular wallet belonging to the owner. In block 906, the data wallet 106 generates, as a function of one or more parameters associated with the wallet, a temporary transaction key to use for the transaction. Such parameters may include user information, timestamp data, and the like. In some embodiments, the data wallet 106 may use other parameters not associated with the wallet to increase obfuscation of other details associated with the wallet or the owner. In block 908, the data wallet 106 transmits the temporary transaction key to the other party. In block 910, the data wallet 106 and external party conduct the transaction using the transaction key to verify identities and authorize the transaction. In block 912, the data wallet 106 generates, using the transaction key, payload data that includes details of the transaction. In block 914, the data wallet 106 records the transaction and payload into the respective blockchain.

In other cases, the owner may initiate a request to conduct a cryptocurrency transaction or a transaction involving an identifier of value in a metaverse. In such a case, rather than send details pertaining to the public key associated with the wallet, the data wallet 106 may instead generate a transaction key identifying the owner as the individual in possession of the wallet. The method 900 describes one possible means of obfuscating wallet address data, but of course, one of skill in the art will recognize that other means can similarly be adapted. By hiding wallet ID information, the platform is able to obfuscate a wallet's activity on chain (as transactions to a blockchain will be signed using the temporary transaction key) and also provide a zero trust environment for the owner, data, and privacy without using seed phrases or wallet keys.

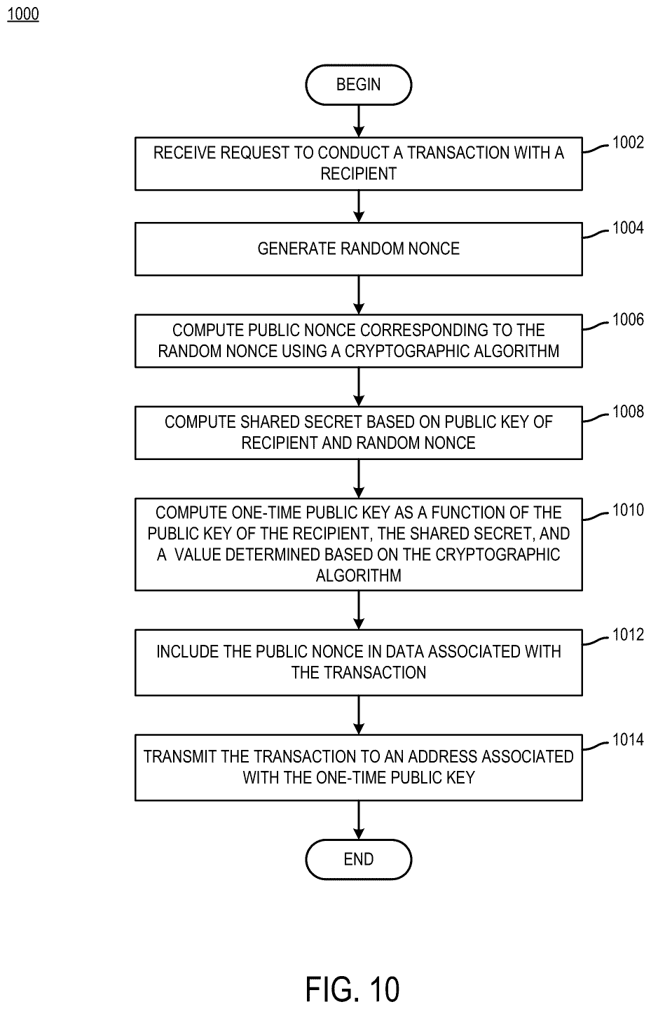

As stated, in an embodiment, stealth address generation techniques may be used to generate a new address on the fly for a transaction such as those mentioned above. Referring now to FIG. 10, the data wallet 106 may perform a method 1000 for generating a stealth address for a secure data wallet transaction. As shown, the method 1000 begins in block 1002, in which the data wallet 106 receives a sender request to conduct a transaction with a recipient. In block 1002, the data wallet 106, on behalf of the sender, generates a random nonce r and, in block 1006, computes the corresponding public nonce R using a cryptographic algorithm, such as elliptic curve cryptography (ECC). In block 1008, the data wallet 106, on behalf of the sender, then computes a shared secret S by multiplying the receiver's public key P with the private nonce r. In block 1010, the data wallet 106 computes the one-time public key Q by adding the receiver's public key P to the product of the shared secret s and the base point G of the elliptic curve. In block 1012, the data wallet 106 includes the public nonce as data to be associated with the transaction. In block 1014, the data wallet 106 transmits the transaction to the one-time public key Q and includes the public nonce R in the transaction data. In the stealth address generation approach, a user only needs to share a single public stealth address from which an unlimited number of unique addresses can be generated, e.g., for receiving funds.

In an embodiment, the stealth address generation techniques may implement a transactional pool in which the wallet management service 116 groups multiple transactions together prior to broadcasting the transactions to the network. The pool collects transactions from various users, mixes the transactions, and broadcasts the transactions as a single large transaction. Advantageously, the transactional pool increases the anonymity set, making it difficult for an attacker to trace individual transactions or identify senders and receivers.

In the transactional pool scheme, a user can transmit a transaction to the transactional pool (which is managed by the wallet management service 116). Upon exceeding a specified threshold (e.g., a threshold for an amount of transactions, a threshold time duration, etc.), the wallet management service 116 constructs, as a function of the transactions, a single large transaction that includes all the inputs and outputs from the pooled transactions. The wallet then broadcasts the combined transaction to the network.

For the purposes of promoting an understanding of the principles of the present disclosure, reference is be made to preferred embodiments and specific language will be used to describe the same. It will nevertheless be understood that no limitation of the scope of the disclosure if thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

One aspect of the present disclosure provides a method of conducting a cryptocurrency wallet transaction within a decentralized Internet platform.

Another aspect of the present disclosure is a system configured to conduct a cryptocurrency wallet transaction within a decentralized Internet platform. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations. Another aspect of the present disclosure provides all that is described and illustrated herein.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

### Examples

Illustrative examples of the technologies of the present disclosure are provided below. An embodiment of the present disclosure may include any one or more, and any combination of, the examples described below.
Example 1 includes a method comprising receiving a request from an external party to conduct a cryptocurrency transaction with a user of a cryptocurrency wallet, the cryptocurrency wallet being instantiated using a public key and a private key; generating a temporary key based on one or more parameters associated with the wallet; and conducting the cryptocurrency transaction using the temporary key in place of the public key.
Example 2 includes the subject matter of Example 1, and wherein the temporary key comprises a one-time public key.
Example 3 includes the subject matter of any of Examples 1 and 2, and wherein generating the temporary key comprises generating a random nonce; computing a public nonce associated with the random nonce using a cryptographic algorithm; computing a shared secret based on a public key of the external party and the random nonce; and computing the one-time public key as a function of the public key of the external party.
Example 4 includes the subject matter of any of Examples 1-3, and further including the public nonce in the transaction; and transmitting the transaction to an address associated with the one-time public key.
Example 5 includes the subject matter of any of Examples 1-4, and further including transmitting the transaction to a pool comprising a plurality of transactions.
Example 6 includes the subject matter of any of Examples 1-5, and further including splitting the private key into a plurality of segments.
Example 7 includes the subject matter of any of Examples 1-6, and further including distributing each of the segments to a plurality of user-selected locations.
Example 8 includes a computer-readable storage medium storing a plurality of instructions, which, when executed by one or more processors, causes a system to receive a request from an external party to conduct a cryptocurrency transaction with a user of a cryptocurrency wallet, the cryptocurrency wallet being instantiated using a public key and a private key; generate a temporary key based on one or more parameters associated with the wallet; and conduct the cryptocurrency transaction using the temporary key in place of the public key.
Example 9 includes the subject matter of Example 8, and wherein the temporary key comprises a one-time public key.
Example 10 includes the subject matter of any of Examples 8 and 9, and wherein to generate the temporary key comprises to generate a random nonce; compute a public nonce associated with the random nonce using a cryptographic algorithm; compute a shared secret based on a public key of the external party and the random nonce; and compute the one-time public key as a function of the public key of the external party.
Example 11 includes the subject matter of any of Examples 8-10, and wherein the plurality of instructions further causes the system to include the public nonce in the transaction; and transmit the transaction to an address associated with the one-time public key.
Example 12 includes the subject matter of any of Examples 8-11, and wherein the plurality of instructions further causes the system to transmit the transaction to a pool comprising a plurality of transactions.
Example 13 includes the subject matter of any of Examples 8-12, and wherein the plurality of instructions further causes the system to split the private key into a plurality of segments.
Example 14 includes the subject matter of any of Examples 8-13, and wherein the plurality of instructions further causes the system to distribute each of the segments to a plurality of user-selected locations.
Example 15 includes a system, comprising one or more processors; and a memory storing a plurality of instructions, which, when executed on the one or more processors, causes the system to receive a request from an external party to conduct a cryptocurrency transaction with a user of a cryptocurrency wallet, the cryptocurrency wallet being instantiated using a public key and a private key; generate a temporary key based on one or more parameters associated with the wallet; and conduct the cryptocurrency transaction using the temporary key in place of the public key.
Example 16 includes the subject matter of Example 15, and wherein the temporary key comprises a one-time public key.
Example 17 includes the subject matter of any of Examples 15 and 16, and wherein to generate the temporary key comprises to generate a random nonce; compute a public nonce associated with the random nonce using a cryptographic algorithm; compute a shared secret based on a public key of the external party and the random nonce; and compute the one-time public key as a function of the public key of the external party.
Example 18 includes the subject matter of any of Examples 15-17, and wherein the plurality of instructions further causes the system to include the public nonce in the transaction; and transmit the transaction to an address associated with the one-time public key.
Example 19 includes the subject matter of any of Examples 15-18, and wherein the plurality of instructions further causes the system to transmit the transaction to a pool comprising a plurality of transactions.
Example 20 includes the subject matter of any of Examples 15-19, and wherein the plurality of instructions further causes the system to split the private key into a plurality of segments; and distribute each of the segments to a plurality of user-selected locations.

1. A method comprising:
receiving a request from an external party to conduct a cryptocurrency transaction with a user of a cryptocurrency wallet, the cryptocurrency wallet being instantiated using a public key and a private key;
generating a temporary key based on one or more parameters associated with the wallet; and
conducting the cryptocurrency transaction using the temporary key in place of the public key.

2. The method of claim 1, wherein the temporary key comprises a one-time public key.

3. The method of claim 2, wherein generating the temporary key comprises:
generating a random nonce;
computing a public nonce associated with the random nonce using a cryptographic algorithm;
computing a shared secret based on a public key of the external party and the random nonce; and
computing the one-time public key as a function of the public key of the external party.

4. The method of claim 3, further comprising:
including the public nonce in the transaction; and
transmitting the transaction to an address associated with the one-time public key.

5. The method of claim 1, further comprising:
transmitting the transaction to a pool comprising a plurality of transactions.

6. The method of claim 1, further comprising:
splitting the private key into a plurality of segments.

7. The method of claim 6, further comprising:
distributing each of the segments to a plurality of user-selected locations.

8. A computer-readable storage medium storing a plurality of instructions, which, when executed by one or more processors, causes a system to:
receive a request from an external party to conduct a cryptocurrency transaction with a user of a cryptocurrency wallet, the cryptocurrency wallet being instantiated using a public key and a private key;
generate a temporary key based on one or more parameters associated with the wallet; and
conduct the cryptocurrency transaction using the temporary key in place of the public key.

9. The computer-readable storage medium of claim 8, wherein the temporary key comprises a one-time public key.

10. The computer-readable storage medium of claim 9, wherein to generate the temporary key comprises to:
generate a random nonce;
compute a public nonce associated with the random nonce using a cryptographic algorithm;
compute a shared secret based on a public key of the external party and the random nonce; and
compute the one-time public key as a function of the public key of the external party.

11. The computer-readable storage medium of claim 10, wherein the plurality of instructions further causes the system to:
include the public nonce in the transaction; and
transmit the transaction to an address associated with the one-time public key.

12. The computer-readable storage medium of claim 8, wherein the plurality of instructions further causes the system to:
transmit the transaction to a pool comprising a plurality of transactions.

13. The computer-readable storage medium of claim 8, wherein the plurality of instructions further causes the system to:
split the private key into a plurality of segments.

14. The computer-readable storage medium of claim 13, wherein the plurality of instructions further causes the system to:
distribute each of the segments to a plurality of user-selected locations.

15. A system, comprising:
one or more processors; and
a memory storing a plurality of instructions, which, when executed on the one or more processors, causes the system to:
receive a request from an external party to conduct a cryptocurrency transaction with a user of a cryptocurrency wallet, the cryptocurrency wallet being instantiated using a public key and a private key;
generate a temporary key based on one or more parameters associated with the wallet; and
conduct the cryptocurrency transaction using the temporary key in place of the public key.

16. The system of claim 15, wherein the temporary key comprises a one-time public key.

17. The system of claim 16, wherein to generate the temporary key comprises to:
generate a random nonce;
compute a public nonce associated with the random nonce using a cryptographic algorithm;
compute a shared secret based on a public key of the external party and the random nonce; and
compute the one-time public key as a function of the public key of the external party.

18. The system of claim 17, wherein the plurality of instructions further causes the system to:
include the public nonce in the transaction; and
transmit the transaction to an address associated with the one-time public key.

19. The system of claim 15, wherein the plurality of instructions further causes the system to:
transmit the transaction to a pool comprising a plurality of transactions.

20. The system of claim 15, wherein the plurality of instructions further causes the system to:
split the private key into a plurality of segments; and
distribute each of the segments to a plurality of user-selected locations.
